(19) United States
(12) Patent Application Publication
(10) Pub. No.: US 2008/0006532 A1
(43) Pub. Date: Jan. 10, 2008

(54) Ammonia and nitrogen oxide sensors

(76) Inventors: Rangachary Mukundan, Los Alamos, NM (US); Eric L. Brosha, Los Alamos, NM (US); Fernando H. Garzon, Santa Fe, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/888,736

(22) Filed: Aug. 1, 2007

Related U.S. Application Data
(63) Continuation-in-part of application No. 11/110,086, filed on Apr. 19, 2005.

(51) Int. Cl. G01N 27/407

(52) U.S. Cl. 204/424

(57) ABSTRACT

The present invention relates to an electrochemical gas sensor for measuring gas concentrations of chemical species. More particularly, the invention relates to an electrochemical sensor that measures ammonia and total nitrogen oxides.

### RELATED APPLICATIONS

This application is a continuation-in-part of application Ser. No. 11/110,086, filed Apr. 19, 2005.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD OF INVENTION

The present invention relates to gas sensors for measuring gas concentrations of chemical species. More particularly, the invention relates to an electrochemical sensor that measures ammonia and total nitrogen oxides.

### BACKGROUND

Exhaust gas generated by combustion of fossil fuels in furnaces, ovens, and engines contains carbon monoxide (“CO”), hydrocarbons (“HC”), and nitrogen oxides (“NOₓ”) (i.e., NO, NO₂, NO₃, N₂O₃, N₂O₄, and N₂O₅). Because NOₓ are an environmental pollutant at the center of public interest, they should be reduced or removed as completely as possible from combustion exhaust gases.

One method of reducing NOₓ emissions uses a catalytic converter to reduce and oxidize NOₓ. The catalyst must be periodically regenerated by a reducing agent such as ammonia (“NH₃”). Both NOₓ and NH₃ are classified as environmental pollutants, so their rate of emission must be within legal limits. Currently, a sensor that monitors and measures both pollutants in a gas stream is unavailable. Thus, an economically produced and reliable commercial NOₓ and NH₃ sensor is unavailable.

### SUMMARY OF INVENTION

The present invention provides an electrochemical sensor comprising (1) a porous ion-conducting solid electrolyte having a fluorite, perovskite, spinel, brownmillerite, or β-alumina structure, and (2) a plurality of electrodes supported by and in communication with the porous ion-conducting solid electrolyte wherein said plurality of electrodes comprises at least one precious metal electrode and at least one metal or metal oxide electrode. In one embodiment the electrolyte has a theoretical density less than 90% and comprises yttria stabilized zirconia (“YSZ”), gadolinia stabilized ceria, or combinations thereof. In another embodiment the plurality of electrodes has a theoretical density greater than 75%.

One embodiment of the present invention provides a solid-state electrochemical sensor that can be used for the detection of reducing/oxidizing gases including NH₃, NOₓ, HC, CO, and H₂. This embodiment has a plurality of electrodes with at least one dense (greater than 75% theoretical density) electrode that is supported by and in communication with a porous (less than 90% theoretical density) electrolyte. Another embodiment of the present invention provides multiple sensors to distinguish gas species. For example, the electrode combination of platinum (“Pt”) and gold (“Au”) operated in the zero current bias mode is sensitive to NH₃. Another example is the electrode combination of Pt and lanthanum chromium based oxide operated in the positive current bias mode. This combination is very sensitive to NO+NO₂+NH₃. In another embodiment the above two sensors can be used in combination to yield the NH₃ and NO+NO₂ concentration of a sample gas. Another embodiment is one sensor with a Pt, an Au, and a lanthanum chromium based oxide electrode wherein the Pt and Au operate in the zero current bias mode and the Pt and lanthanum chromium based oxide operate in the positive current bias mode to again yield the NH₃ and NO+NO₂ concentration of a sample gas.

### BRIEF DESCRIPTION OF DRAWINGS

FIG. 1 is a schematic representation of an electrochemical sensor of the present invention.

FIG. 2 is a flow chart of a method of making a sensor.

FIG. 3a is a schematic representation of an electrolyte tape-cast onto a carrier.

FIG. 3b is a schematic representation showing electrodes in contact with a wet face of a first portion of cast electrolyte tape.

FIG. 3c is a schematic representation showing the cast electrolyte tape folded over to partially enclose the electrodes.

FIG. 4a is a schematic representation showing multiple electrode pairs in contact with a wet face of a first portion of cast electrolyte tape.

FIG. 4b is a schematic representation showing the cast electrolyte tape folded over to partially enclose the multiple pairs of electrodes.

FIG. 5 shows the NH₃ response of a Pt/YSZ/Au sensor. Also shown is the response of other common interference gases.

FIG. 6 shows the NH₃ response of a Pt/YSZ/Au sensor over ten days.

FIG. 7 shows the NH₃ response of a Pt/YSZ/La_{0.8}Sr_{0.2}CrO₃ at 0.0 microamps (“μA”) and 0.5 μA current bias.

FIG. 8 shows the NO, NO₂, CO, NH₃, C₃H₆, and C₃H₈ responses of two Pt/YSZ/La_{0.8}Sr_{0.2}CrO₃ sensors at 0.5 μA current bias.

### DETAILED DESCRIPTION

The present invention relates to an electrochemical sensor that measures NH₃ and NOₓ in a gas stream. Electrochemical sensors operate by reacting with the gas of interest and producing an electrical signal proportional to the gas concentration. A typical electrochemical gas sensor consists of a sensing electrode and a counter electrode on a solid electrolyte. Multiple oxidation-reduction reactions occur between the gas of interest and the electrodes and cause mixed potentials of differing magnitudes to occur between the dissimilar electrodes. This potential can be measured to determine the gas concentration. Additionally, certain gases (e.g., NOₓ, non-methane HC, etc) can result in a change in the electrolyte/electrode interface resistance. This change can be measured as a voltage (or current) change while applying a constant current (or voltage) bias.

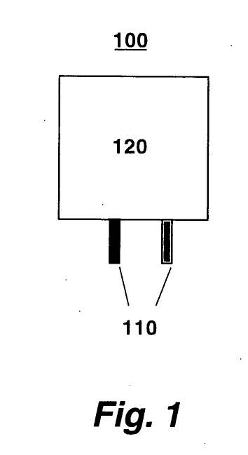

FIG. 1 is a schematic representation of an electrochemical sensor of the present invention. Electrochemical sensor (“sensor”) 100 comprises a plurality of electrodes 110. A portion of each of the plurality of electrodes 110 is embedded between two portions of a tape-cast electrolyte 120. In most instances, the sensor has two electrodes, but sensor 100 may have more than two electrodes 110 when detection of multiples gaseous species by sensor 100 is desired. The plurality of electrodes 110 includes at least two electrodes that are dissimilar to each other. When a gaseous specie (or species) catalytically reacts with each of the dissimilar electrodes, a potential difference is generated between electrodes 110. The potential difference translates into an output signal for sensor 100 that corresponds to the concentration of the gaseous specie or species.

In one embodiment, sensor 100 is a non-Nernstian sensor. For the purposes of understanding the invention, a non-Nernstian sensor is an electrochemical sensor in which the voltage deviates from the theoretical voltage obtained when all the gaseous species and charge carriers are in thermodynamic equilibrium with each other. In a particular embodiment, the non-Nernstian sensor is a mixed potential sensor; that is, a non-Nernstian sensor in which the voltage is determined by the reaction rates of at least two species undergoing electrochemical oxidation-reduction reactions at the three-phase electrode/electrolyte/gas interface. In another embodiment, sensor 100 is a resistive sensor; that is a sensor in which the reaction resistance at the electrode/electrolyte interface is determined by the concentration of the gas species. The change in reaction resistance can be measured by a positive voltage, a negative voltage, or current bias.

Each of the plurality of electrodes 110 comprises at least one electronically conductive material. The electronically conductive material comprises at least one of an oxide, a metal, a semiconductor, and combinations thereof. The at least one electronically conducting material has an electronic conductivity of greater than 10 mS/cm at a temperature in a range from about 300° C. to about 1000° C. In one embodiment, the electronically conductive material comprises at least one of Pt, Au, lanthanum chromium based oxide, and combinations thereof. The lanthanum chromium based oxide includes lanthanum chromium based oxides in which at least one of calcium, strontium, and magnesium has been substituted or doped for a portion of the lanthanum. Generally, the lanthanum chromium based oxide that has been doped has the formula La_{1-X}(Ca, Sr, Mg)_{X}CrO₃ where X ranges from about 0.00 to about 0.6. Moreover, the lanthanum chromium based oxide also includes lanthanum chromium based oxides in which at least one of manganese, magnesium, iron and cobalt has been substituted or doped for a portion of the chromium. Generally, if both the lanthanum and chromium have been substituted or doped then the lanthanum chromium based oxide has the formula La_{1-X}(Ca, Sr, Mg)_{X}Cr_{1-Y}(Mn, Mg, Fe, CO)_{Y}O₃ where X ranges from about 0.0 to about 0.6 and Y ranges from about 0.0 to about 0.6. Each of the plurality of electrodes 110 comprises at least one of a metal wire, metal foil, a pellet, a tape, and combinations thereof.

Tape-cast electrolyte 120 comprises an ionic conducting material. In one embodiment, the ionic conducting material is an inorganic oxide that has a fluorite, perovskite, brownmillerite, or β-alumina crystal structure. Ionic conducting materials used in tape-cast electrolyte 120 include, but are not limited to, YSZ, gadolinia stabilized ceria, and combinations thereof. Moreover, techniques including extrusion, dip coating, spray coating, tape calendaring, screen printing, sputtering, e-beam evaporation, plasma deposition and the like can be substituted for tape casting by one skilled in the art to create a similar device wherein a plurality of electrodes with at least one dense electrode (i.e., theoretical density greater than 75%) is supported on an electrolyte body.

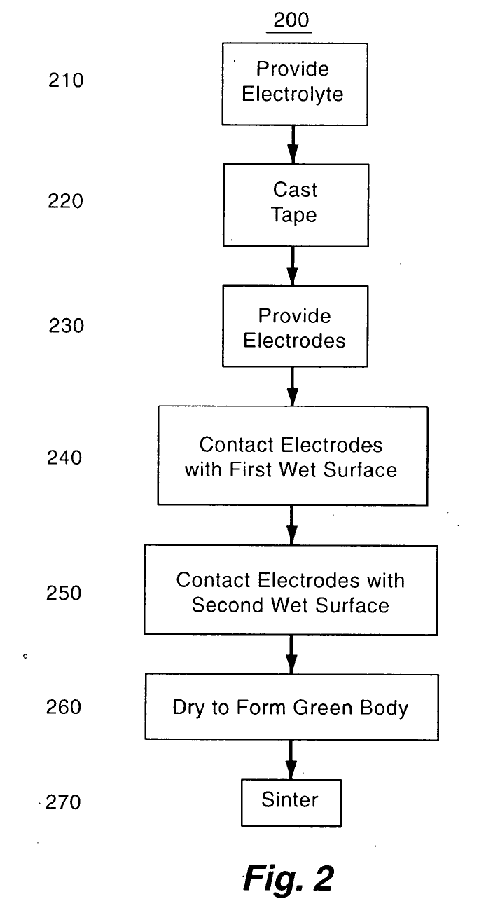

FIG. 2 is a flow chart that illustrates the method 200 of making sensor 100. First, at least one electrolyte, such as, but not limited to, YSZ or gadolinia stabilized ceria, is provided in powder form (Step 210). The electrolyte powder may be dried. Typically, the powder is dried at a temperature in a range from about 100° C. to about 150° C. for approximately one hour. The dried powder is then mixed with at least one solvent, such as xylene, ethyl alcohol, fish oil, or the like, and ball milled. Plasticizers and binders, such as, but not limited to, S-160, (benzyl butyl phthalate), UCON (polyalkylene glycol), B-98 (polyvinyl butyral), and the like are then added to the mixture of powder and solvent, followed by further ball milling to form a slurry. Ball milling times are generally about 24 hours, and, after milling, the mill is discharged and de-aired for approximately 10 minutes at approximately 20-25 inches of Hg (510-635 mm Hg).

In Step 220, the slurry is cast as a tape onto a carrier using tape casting methods that are well known in the art. In one embodiment, the slurry is tape cast onto a Si-coated Mylar (G10JRM) carrier film using a standard doctor blade apparatus, the apparatus having a gap in a range from about 0.05 inches (about 1.27 mm) to 0.2 inches (about 5.1 mm).

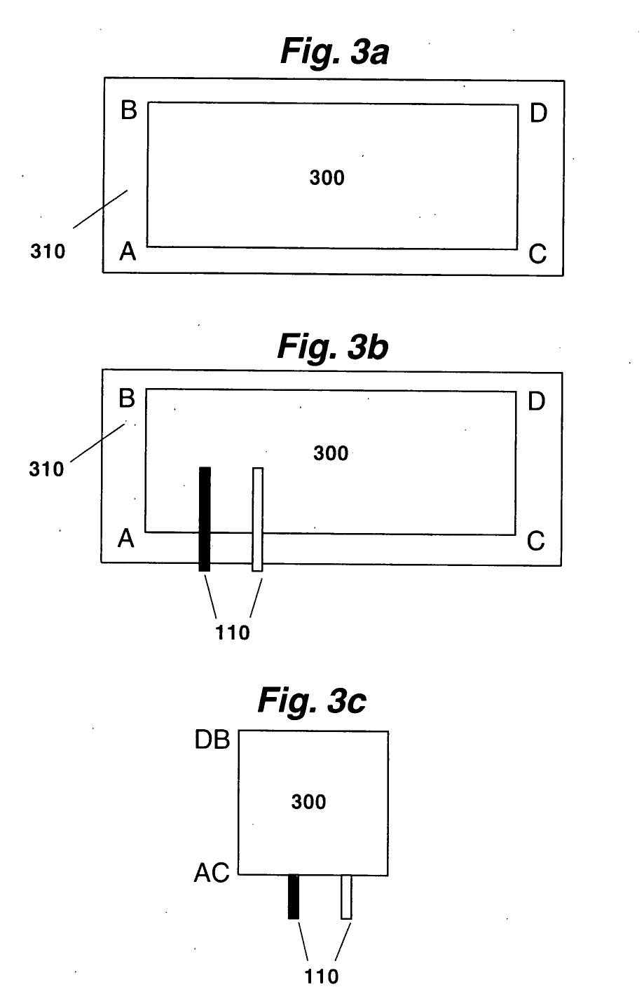

Once cast, tape 300 (shown in FIGS. 3a, 3b, and 3c) is allowed to partially dry. Drying typically takes between approximately 10 to 20 minutes. At this point, the outer face of the tape (i.e., the surface of the tape facing air) is dry and the inner face of the tape in contact with the carrier film is still very wet. The wet inner face of the tape is still sticky or tacky, and is capable of wetting the surface of any material that comes in contact with it. In contrast to the inner face, the dry outer face is not sticky and provides the tape with enough mechanical stability to allow the tape to be handled. The tape is then reversed so as to expose the wet inner face to air while contacting the dry side with the carrier film. FIG. 3a is a schematic diagram showing the tape 300 disposed on carrier 310, with the wet inner face (or surface) of tape 300 facing upward. Characters A, B, C, and D identify the four corners of tape 300.

In Step 230, a plurality of electrodes 110, described hereinabove, is provided. Electrodes 110 are pre-fabricated. Electrodes 110 are then brought into contact with the wet inner face (or surface) of a first portion of tape 300 in Step 240. Electrodes 110 may be lightly pressed into the wet inner face. FIG. 3b shows electrodes 110 in contact with the wet inner face (or surface) of the first portion of tape 300. In Step 250, a second portion the wet inner face (or surface) of tape 300 is then brought into contact with the plurality of electrodes 110 so as to partially enclose the plurality of electrodes 110 within the tape 300 cast from electrolyte 120. In one embodiment, shown in FIG. 3c, tape 300 is folded on to itself, so that corners C and D of tape 300 meet corners A and B, respectively. As an alternative to folding tape 300 onto itself, another segment of tape 300 having a wet face and a dry face may be placed over the first segment of tape 300, which is already in contact with electrodes 110, so that the wet faces of the different tape segments contact each other such that electrodes 110 are sandwiched or embedded between the wet tapes and are partially covered (i.e., a portion of each electrode 110 extends beyond tape 300 and is exposed). The resulting cast electrolyte tape 300 with partially enclosed electrodes 110 is then allowed to air dry fully to form a green sensor body (Step 260). The green sensor body is then sintered to form sensor 100 in Step 270. In one embodiment, Step 270 includes removal of the binder prior to sintering. In one non-limiting example, the binder is first removed by heating the green sensor body from room temperature to about 500° C. at a rate of about 2° C./min and held at about 500° C. for approximately 1 hour. The green sensor body is then heated from 500° C. to about 625° C. at a rate of about 1° C./min and held at that temperature for about 1 hour. After removal of the binder, the green sensor body is sintered by heating the sensor body to a temperature in the range from about 1000° C. to about 1200° C. at a rate of about 5° C./min. The sensor body held at temperature for about 10 hours, and then allowed to cool to room temperature at a rate of about 5°/min. The sintering temperature is selected to yield a porous electrolyte and also depends upon the particular materials used to form the plurality of electrodes 110 and tape-cast electrolyte 120. For example, gold-based electrodes are sintered at about 1000° C. whereas lanthanum chromite electrodes are sintered at about 1200° C.

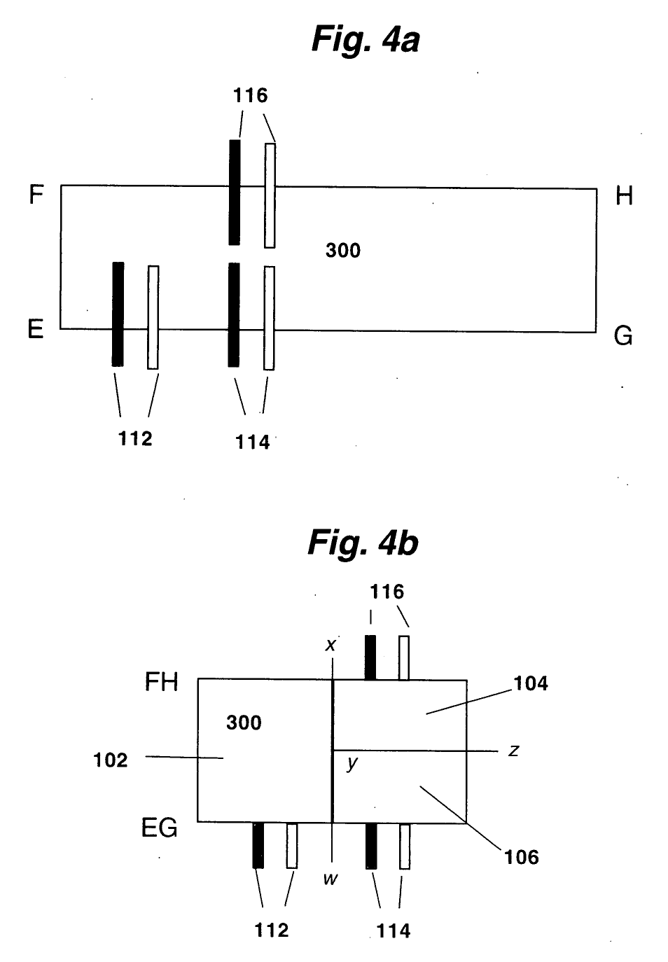

In another embodiment, method 200 is adapted to prepare a plurality of sensors 100. For example, a number of electrodes 110 sufficient to make a number of 100 sensors may be provided to the wet face or surface of the first portion of tape 300. In the example shown in FIG. 4a, three pairs of dissimilar electrodes 112, 114, 116 are brought into contact with tape 300. A wet face or surface of a second portion of tape 300 is then brought into contact with the electrode pairs and the wet face of the first portion of tape 300 so as to partially enclose the plurality of electrodes 110 within the tape 300 cast from electrolyte 120. In the embodiment shown in FIG. 4b, tape 300 is folded on to itself, so that corners G and H of tape 300 meet corners E and F, respectively. Individual sensors 102, 104, 106 are then obtained by cutting the green tape 300 along lines wx and yz. The green tape may be cut either by hand, such as by a razor blade or scissors, or by mechanical cutting instruments known in the art. As many electrode combinations as needed may be placed in between the tapes to form multiple sensors. As previously described, the plurality of electrodes 110 may comprise metal wires, metal foils, ceramic pellets, ceramic tapes, and combinations thereof. Whereas the sensors shown in FIGS. 1, 3b, 3c, 4a, and 4b each have two electrodes, sensors having more than two electrodes may also be easily made using method 200.

Sensor 100 may be operated in a zero current/voltage mode, a positive voltage/current bias mode, or a negative voltage/current bias mode. In the zero current mode, the sensor behaves like a true mixed-potential sensor because a voltage develops depending on the rates of the various electrochemical reactions occurring at the different electrodes. For example, the voltage is more negative than the equilibrium voltage for reducing gases such as HC, CO, and NO. Conversely, the voltage is more positive than the equilibrium voltage for oxidizing gases such as NO₂. When compared to the Pt electrode, the voltage developed in the zero current mode is greater in magnitude on the lanthanum chromium based oxide or Au electrodes. Therefore, if operated in the zero-current mode with the Pt electrode connected to the instrument positive and the Au or lanthanum chromium based oxide electrode connected to instrument negative, then HC, NO, and CO each produce a positive voltage response whereas NO₂ produces a negative voltage response. If operated in the zero voltage mode, then the same sensor would yield a positive current for HC, NO, and CO and a negative current for NO₂.

In a zero current/voltage mode, a positive voltage/current bias mode, or a negative voltage/current bias mode, sensor 100 response is a mixed potential response superimposed on a resistance change. This resistance change is due to the electrode reactions in which resistance decreases with the addition of NO, NO₂, or non-methane hydrocarbons. If the sensor is operated in a positive current bias mode, the resistance change results in a lowering of the sensor voltage when NO and NO₂ are introduced. The magnitude of this response with respect to NO and NO₂ is very similar. These two gases tend to give identical sensor responses in the bias mode, especially when their response in the zero bias mode is negligible. On the other hand, the bias current can be adjusted so as to zero out the voltage generated due to the HC. Similarly, in the positive voltage bias mode the response to NO and NO₂ is an increase in current and the HC interference can be cancelled out. Thus, the Pt/YSZ/lanthanum chromium based oxide sensor acts as HC sensor in the zero bias mode and as total NO_{X} sensor in the positive bias mode.

In currently available bulk sensors, NO and NO₂ responses depend upon environmental conditions, making any determination of total concentration of NO_{X} gases from the sensor output difficult. In many cases, either additional measurements are necessary or catalysts or pumping cells are required to convert all the NO_{X} gases to a single species. Because NO and NO₂ produce identical responses in the tape-cast sensor, sensor 100 is particularly suitable for use as a total NO_{X} sensor without using any additional gas or requiring additional data processing or measurements.

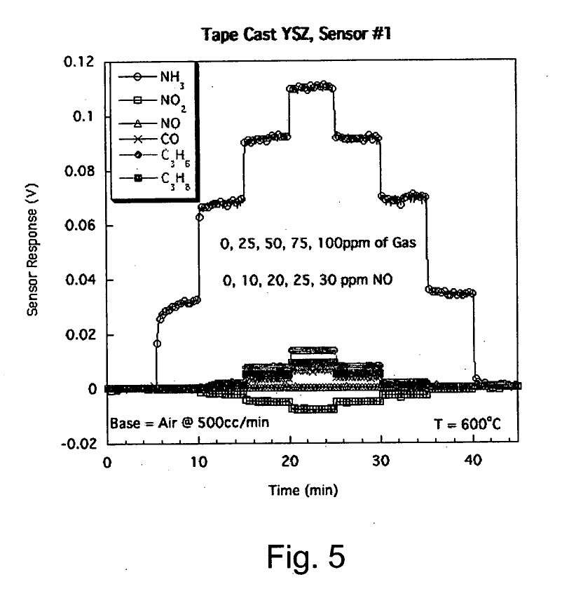

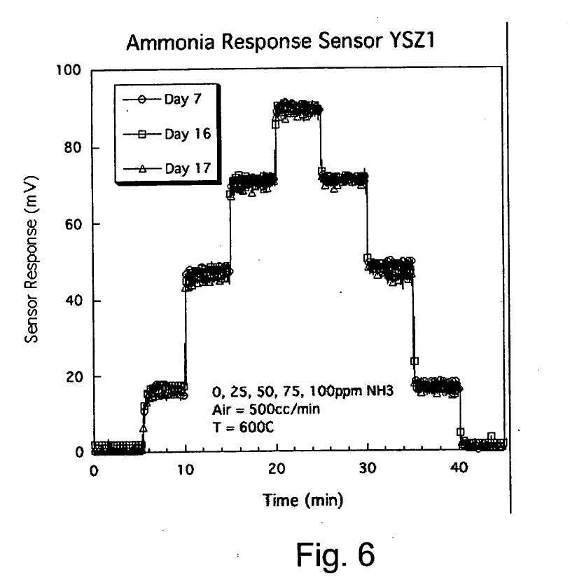

The ability of sensor 100 to use different electrodes and to operate in various bias modes enables sensor 100 to detect several gaseous species without interference due to the presence of other gases. Sensor 100 with a Pt electrode, a Au electrode, and an YSZ electrolyte operated in zero bias mode functions as a very selective NH₃ sensor. FIG. 5 shows the NH₃ selectivity is at least 10 times over NO, NO₂, CO, C₃H₆ and C₃H₈. The use of Pt and Au wire electrodes for a mixed-potential type sensor using a pressed pellet type ceria electrolyte has been described for the detection of gases like CO (U.S. Pat. No. 6,605,202 B1). However, the present sensor uses YSZ as the electrolyte and is selectively sensitive to NH₃. The CO response of this device is 10 times lower than the NH₃ sensitivity. The selectivity of this device can be tuned by adjusting the operating temperature. Moreover there is almost no change in the voltage response to 25-100 ppm of NH₃ during a period of 10 days (FIG. 6). Additionally, the density of the electrolyte of the present sensor is limited to <90% of theoretical density. This limitation guarantees that the electrolyte has enough porosity for gas access. This porosity controls the response time and sensitivity of the sensor at any given operating temperature because greater porosity leads to faster response times and lower sensitivity.

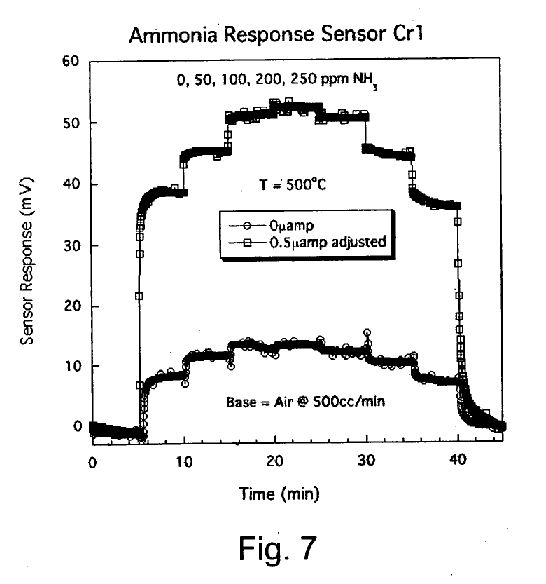

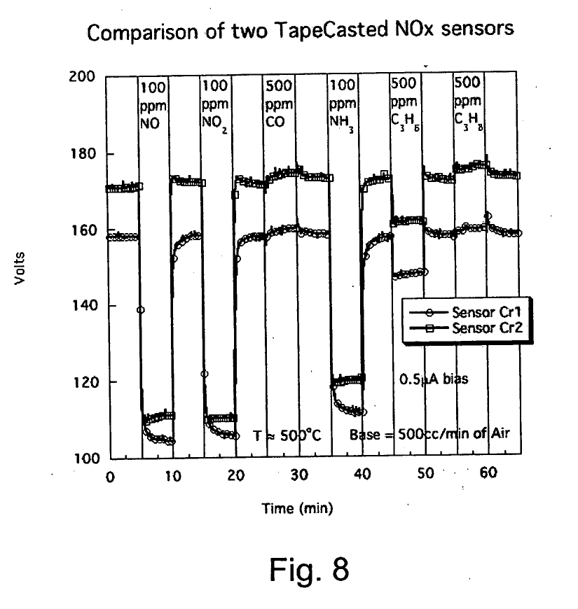

Sensor 100 with a Pt electrode, a lanthanum chromium based oxide electrode, and an YSZ electrolyte operated under a positive current bias mode is very selective to NO, NO₂ (as demonstrated in US-2006-0231420-A1, US-2006-0231987-A1, and Mukundan et al, Nitrogen Oxide Sensors Based on Yttria-Stabilized Zirconia Electrolyte and Oxide Electrodes, Electrochemical and Solid State Letter, 10(2) J26-J29 (2007)) and NH₃. FIG. 7 shows that sensor 100 with a Pt electrode, a La_{0.8}Sr_{0.2}CrO₃ electrode, and an YSZ electrolyte operated under a positive current bias mode (0.5 μA) is much more sensitive to NH₃ than the same sensor operated in a zero bias mode. Therefore the bias of the sensor can be used to tune the sensitivity of the sensor to various sensing gases. Moreover the response of the sensor (if operated under a 0.5 μA bias) to NO, NO₂, and NH₃ are almost equal (FIG. 8). Thus the sensor can be used to measure the total nitrogen present in a non-inert (not N₂) form like NO, NO₂, N₂O, NH₃ etc.

Combining the sensors of paragraph [0032] and [0033] yields a total NO_{X} and NH₃ sensor. The Pt/YSZ/Au sensor is selective to NH₃ in the presence of NO_{X}. The output of this sensor can be used to calculate the NH₃ concentration (using a calibration curve) in a gas stream that contains NO_{X}. This NH₃ concentration can then be used along with the response of a Pt/YSZ/La_{1-X}(Ca, Sr, Mg)_{X}Cr_{1-Y}(Mn, Mg, Fe, CO)_{Y}O₃ (where X ranges from about 0.0 to about 0.6 and Y ranges from about 0.0 to about 0.6) sensor operating in the bias mode (total NOₓ+NH₃ sensor) to calculate the total NO_{X} content of the gas stream. In this configuration both sensors can be heated to different temperatures using two independent feedback controlled heaters incorporated onto each of the sensor bodies.

In another embodiment the same device can be achieved with one sensor that contains one Pt, one Au, and one lanthanum chromium based oxide electrode with the voltage at zero current bias being measured between the Pt and Au electrodes and the voltage at a positive current bias being measured between the Pt and lanthanum chromium based oxide electrodes. The voltage between the Pt and Au electrodes is indicative of the NH₃ concentration that can then be used along with the signal from the Pt and lanthanum chromium based oxide electrodes to yield the total NO_{X} concentration.

Although typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

All publications, patents, and patent applications cited in this specification are herein incorporated by reference as if each individual publication or patent application were specifically and individually indicated to be incorporated by reference.

We claim:

1. An electrochemical sensor comprising
(a) a porous ion-conducting solid electrolyte having a fluorite, perovskite, spinel, brownmillerite, or β-alumina structure, and
(b) a plurality of electrodes supported by and in communication with said porous ion-conducting solid electrolyte wherein said plurality of electrodes comprises at least one precious metal electrode and at least one metal or metal oxide electrode.

2. The electrochemical sensor of claim 1 wherein said porous ion-conducting solid electrolyte has a theoretical density less than 90% and comprises yttria stabilized zirconia, gadolinia stabilized ceria, or combinations thereof.

3. The electrochemical sensor of claim 2 wherein said plurality of electrodes has a theoretical density greater than 75%.

4. The electrochemical sensor of claim 3 wherein said electrochemical sensor is operable in one of a zero current/voltage mode, a positive voltage/current bias mode, or a negative voltage/current bias mode.

5. The electrochemical sensor of claim 4 wherein said porous ion-conducting solid electrolyte is yttria stabilized zirconia, said at least one precious metal electrode is platinum, said at least one metal or metal oxide electrode is gold, and said electrochemical sensor operates in a zero bias mode.

6. The electrochemical sensor of claim 4 wherein said porous ion-conducting solid electrolyte is yttria stabilized zirconia, said at least one precious metal electrode is platinum, said at least one metal or metal oxide electrode is a lanthanum chromium based oxide, and said electrochemical sensor operates in a positive current bias mode.

7. The electrochemical sensor of claim 6 wherein said lanthanum chromium based oxide is La_{1-X}(Ca, Sr, Mg)_{X}Cr_{1-Y}(Mn, Mg, Fe, Co)_{Y}O₃ where X ranges from about 0.0 to about 0.6 and Y ranges from about 0.0 to about 0.6.

8. The electrochemical sensor of claim 3 wherein said porous ion-conducting solid electrolyte is yttria stabilized zirconia, said plurality of electrodes contains a platinum electrode, a gold electrode, and a lanthanum chromium based oxide electrode.

9. The electrochemical sensor of claim 8 wherein said lanthanum chromium based oxide is La_{1-X}(Ca, Sr, Mg)_{X}Cr_{1-Y}(Mn, Mg, Fe, CO)_{Y}O₃ where X ranges from about 0.0 to about 0.6 and Y ranges from about 0.0 to about 0.6.

10. The electrochemical sensor of claim 8 wherein said electrochemical sensor operates in a zero current bias mode between said platinum electrode and said gold electrode and said electrochemical sensor operates in a positive current bias mode between said platinum electrode and said lanthanum chromium based oxide electrode.

11. The electrochemical sensor of claim 10 wherein said lanthanum chromium based oxide is La_{1-X}(Ca, Sr, Mg)_{X}Cr_{1-Y}(Mn, Mg, Fe, CO)_{Y}O₃ where X ranges from about 0.0 to about 0.6 and Y ranges from about 0.0 to about 0.6.

12. An electrochemical sensor comprising
(a) a porous ion-conducting solid electrolyte having a fluorite, perovskite, spinel, brownmillerite, or β-alumina structure, and
(b) a plurality of electrodes supported by and in communication with said porous ion-conducting solid electrolyte wherein said plurality of electrodes comprises a first set of electrodes and a second set of electrodes wherein said first set of electrodes comprises at least one precious metal electrode and at least one metal or metal oxide electrode and said second set of electrodes comprises at least one precious metal electrode and at least one metal or metal oxide electrode.

13. The electrochemical sensor of claim 12 wherein said porous ion-conducting solid electrolyte has a theoretical density less than 90% and comprises yttria stabilized zirconia, gadolinia stabilized ceria, or combinations thereof.

14. The electrochemical sensor of claim 13 wherein said plurality of electrodes has a theoretical density greater than 75%.

15. The electrochemical sensor of claim 14 wherein said electrochemical sensor is operable in one of a zero current bias mode, a zero voltage bias mode, a positive current bias mode, and a positive voltage bias mode.

16. The electrochemical sensor of claim 15 wherein said porous ion-conducting solid electrolyte is yttria stabilized zirconia, said first set of electrodes comprises platinum and gold, and said second set of electrodes comprises platinum and a lanthanum chromium based oxide.

17. The electrochemical sensor of claim 16 wherein said lanthanum chromium based oxide is La_{1-X}(Ca, Sr, Mg)_{X}Cr_{1-Y}(Mn, Mg, Fe, CO)_{Y}O₃ where X ranges from about 0.0 to about 0.6 and Y ranges from about 0.0 to about 0.6.

18. The electrochemical sensor of claim 16 wherein said first set of electrodes operates at zero current bias mode and said second set of electrodes operates at a positive current bias mode.
